(19) United States
(12) Patent Application Publication
(10) Pub. No.: US 2025/0267604 A1
(43) Pub. Date: Aug. 21, 2025

(54) Time Synchronization in High Latency Networks

(71) Applicant: Itron, Inc., Liberty Lake, WA (US)

(72) Inventors: Tamas Benics, Budapest (HU); John Martin Power, Dublin (IE); Cristian Govor, Budapest (HU)

(21) Appl. No.: 18/444,459

(22) Filed: Feb. 16, 2024

(51) Int. Cl. H04W 56/00; G16Y 10/75

(52) U.S. Cl. CPC H04W 56/004; G16Y 10/75

(57) ABSTRACT

Techniques for synchronizing devices on a high-latency network include obtaining a timestamp (e.g., time-data, such as date-and-time-data) from a secure source in the network. It is determined if a global network satellite system (GNSS) signal timestamp is available. Such a timestamp may be more accurate than the network timestamp due in part to latency. If the GNSS signal timestamp is available, it is validated if it is within a first threshold time period from the timestamp. If the GNSS timestamp is not validated, it is determined if a cellular network timestamp is available from a cellular network. If the cellular network timestamp is available, it is validated if it is within a second threshold time period from the timestamp. An onboard clock is set based at least in part on a time-source that could be validated.

### BACKGROUND

In some internet-of-things (IoT) applications, dedicated-purpose networks, and/or cellular communications systems, an accurate time is necessary for the operation of a networked device. However, network latency, cellular network unavailability, and/or jammed or unavailable global navigational satellite system (GNSS) signals result in inaccurate and/or non-synchronized clock times. This can result in incorrect cellular billings, errors in packet transmission over one or more networks, problems in software execution, and other time-related issues.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1A is a block diagram showing an example system including networks having different communications latencies—e.g., a high-latency network, a cellular network (within which the high-latency network may be contained), and a global navigational satellite system (GNSS)—and showing how clocks of devices in such a system may be set and reset.

FIG. 1B is a block diagram showing added detail of the clocks of a networked device in the example network.

FIGS. 2A, 2B, and 2C are a sequence of flowcharts, showing example event sequencing from power-on reset to a determination of validity of clocks set to time signals from different systems and/or networks.

FIG. 3A and 3B are a sequence of flowcharts, showing example event sequencing as an onboard clock of a networked device is updated, based in part on a determination of the validity of time-data from networks having different degrees of communications latency.

FIG. 4 is a flowchart showing an example method of operation of a networked device, wherein techniques for selecting an appropriate time-source from an appropriate network for use by the device are described.

FIG. 5 is a flowchart showing an example method by which the onboard clock of a networked device may be reset to use GNSS network-sourced time-data after the GNSS time-data was found to be valid.

FIG. 6 is a flowchart showing an example by which the onboard clock may be reset using cellular network-sourced time-data.

FIG. 7 is a flowchart showing an example by which the onboard clock may be reset to use narrow band internet of things (NB-IoT) network-sourced time-data after a GNSS time-source is found to be invalid.

FIG. 8 is a flowchart showing an example by which the onboard clock may be reset to use NB-IoT network-sourced time-data after a cellular time-source is found to be invalid.

FIG. 9 is a flowchart showing a further example of operation of a networked device performing techniques for time synchronization in a system comprising networks having different communications latencies.

FIG. 10 is a flowchart showing an example showing how latency of a network may be estimated and showing how thresholds—used to determine if a first time-source should be replaced by a second time-source—may be adjusted.

FIG. 11 is a flowchart showing an example by which a network device uses a GNSS time-source if it is validated, but uses a valid cellular time-source if the GNSS time-source is not validated.

FIG. 12 is a flowchart showing an example by which a network device switches from a time-source in a network having higher latency to a time-source in a network having lower latency.

### DETAILED DESCRIPTION

### Overview

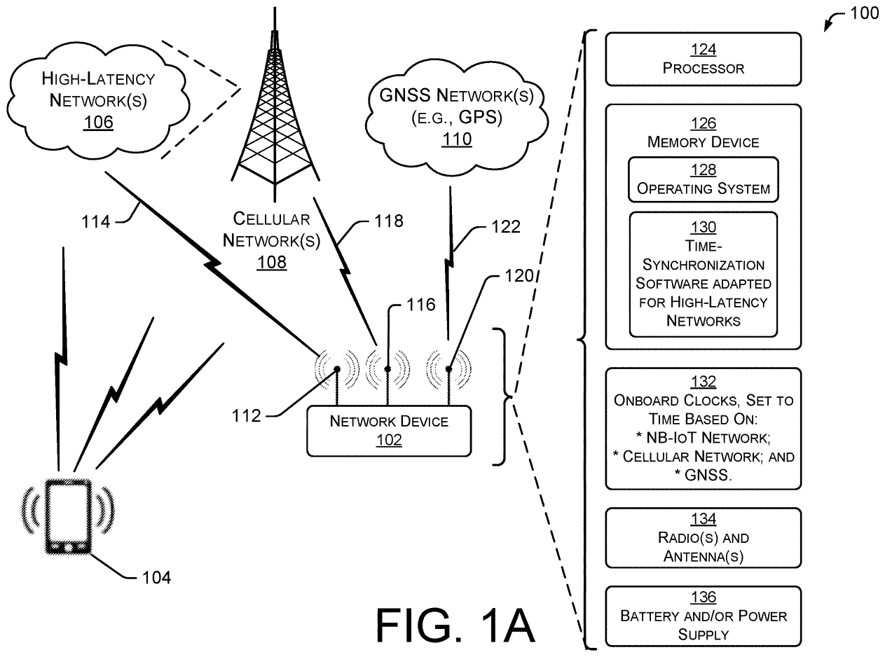

FIG. 1A is a block diagram showing an example system including networks having different communications latencies—e.g., a high-latency network, a cellular network (within which the high-latency network may be contained), and a global navigational satellite system (GNSS). The diagram also shows how clocks of devices in the system may be set and reset. In the example system, a network having a higher communications latency may provide a valid timestamp; however, the communications latency of the network may delay arrival of the timestamp by an unknown amount. Other networks—e.g., cellular and GNSS networks—may have less communications latency, but may not be reliably available.

In example techniques, a timestamp (e.g., time-data, such as date and/or time-data) is obtained from a lightweight machine to machine (LwM2M) registration process. Such a timestamp may be sent by a Narrow Band Internet of Things (NB-IoT) server (e.g., an NB-IoT time-source). In one example, the registration may be made using public/private key cryptography techniques for security. However, the timestamp obtained in this manner may not be as accurate as desired and/or required, due to travel over the high-latency network. In an example of a high-latency network, the Open Mobile Alliance (OMA) LwM2M protocol provides transport binding for NB-IoT devices deployed over a cellular IoT access network. The protocol provides highly efficient data formats and streamlined messages for lossy networks with low bandwidth, which are particularly helpful to low-power devices with little computing power.

In a process to replace the timestamp sent by the NB-IoT time-source with a more accurate timestamp, it is determined if a global navigation satellite system (GNSS) signal timestamp is available. The global positioning system (GPS) operated by the U.S. government is an example of a GNSS. The timestamp acquired from a GNSS may be more accurate than the NB-IoT server's timestamp due in part to latency in the network over which the NB-IoT server's timestamp traveled. However, the GNSS timestamp may be corrupted or missing (e.g., due to an object blocking the signal, or jamming by military actions), or incorrect (e.g., due to “spoofing”). In some examples, if the GNSS timestamp is within a first threshold time period of the NB-IoT server's timestamp, the GNSS timestamp is considered to be valid. The first threshold time period is selected to determine if the GNSS timestamp close enough to the NB-IoT server's timestamp for the GNSS timestamp to be considered “reasonable.” If reasonable, then the GNSS timestamp is probably more accurate than the NB-IoT timestamp, due to the latency of the network over which the NB-IoT timestamp traveled. The first threshold time period may be based at least in part on the latency of the network used by the NB-IoT server. That is, the first threshold may be longer if the network is slower, etc.

If the GNSS timestamp is unavailable or not within the threshold period of the timestamp sent by NB-IoT server, the GNSS timestamp may not be validated. For example, the GNSS timestamp may be outside of a time window or threshold based on the latency of the network used by the NB-IoT server. In that case, it is determined if a cellular network timestamp is available from a cellular network. If the cellular network timestamp is available, it is validated (i.e., considered to be valid) if it is within a second threshold time period from the timestamp from the NB-IoT server. The first threshold and the second threshold may be the same value, or different values, depending on the systems involved. If validated, the cellular network timestamp may be used by the network device.

GNSS is used extensively in this document to refer to global navigation satellite system(s). For purposes of convenience, time-sources such as time beacons are also referred to herein when referring to GNSS. An example time beacon is operated by the National Institute of Standards and Technology (NIST) of the United States government, and includes radio stations WWV and WWVH. Such time beacons are considered to be under the umbrella of the term GNSS. This is appropriate in that some GNSS obtain time-data from the sources (e.g., atomic clocks) also used by such time beacons.

An onboard clock of a network device is set and reset based at least in part on time-sources (NB-IoT server, cellular network, GNSS, etc.) that may transition between valid and invalid (or, invalid and valid) over time.

### Example System and Techniques

FIG. 1A shows aspects of an example system 100 having a high-latency network that is configured for time synchronization. Two example network devices are shown, including network device 102 and cellular telephone 104. The two devices each communicate with one or more of a high-latency network(s) 106, a cellular network(s) 108, and a global navigational satellite system 110 (GNSS). In an example, the high-latency network(s) 106 is a sub-network of the cellular network(s) 108. That is, the cellular network(s) 108 may provide the high-latency network as a feature that is used in some applications based on considerations of cost, speed, throughput, etc. In some examples, the high-latency network(s) 106 are networks used to manage devices within an internet of things (IoT) environment. In an example, coverage may be available for multiple cellular networks, and one or more cellular network(s) 108 from among those networks may be used by the devices 102, 104. In a further example, the GNSS networks or systems 110 may include networks such as the well-known GPS network, and/or other networks sponsored by one or more different countries and/or corporations, etc.

In the example shown, the network device 102 has an antenna 112 and associated radio configured to communicate using signal(s) 114, sent to, and/or received from, a node (e.g., an adjacent device and/or a data collector) within the high-latency network 106. Additionally, the network device 102 has an antenna 116 and associated radio configured to communicate using signal(s) 118, sent to, and/or received from, a node (e.g., cellular tower) within cellular network(s) 108. And further, the network device 102 has an antenna 120 and associated radio configured to communicate using signal(s) 122, sent to, and/or received from, a node (e.g., a GPS satellite) within a GNSS system or network 110.

The cellular telephone 104 may be similarly equipped with some or all of the radios and antennas described for access to the networks 106, 108, and/or 110.

An example structure of the network device 102 is shown, and is representative of devices adaptable for use in the system 100. A processor 124 is configured to communicate with a memory device 126, which may contain executable programs (e.g., applications). In the example, an operating system 128 and time-synchronization software adapted for high-latency networks 130 is shown.

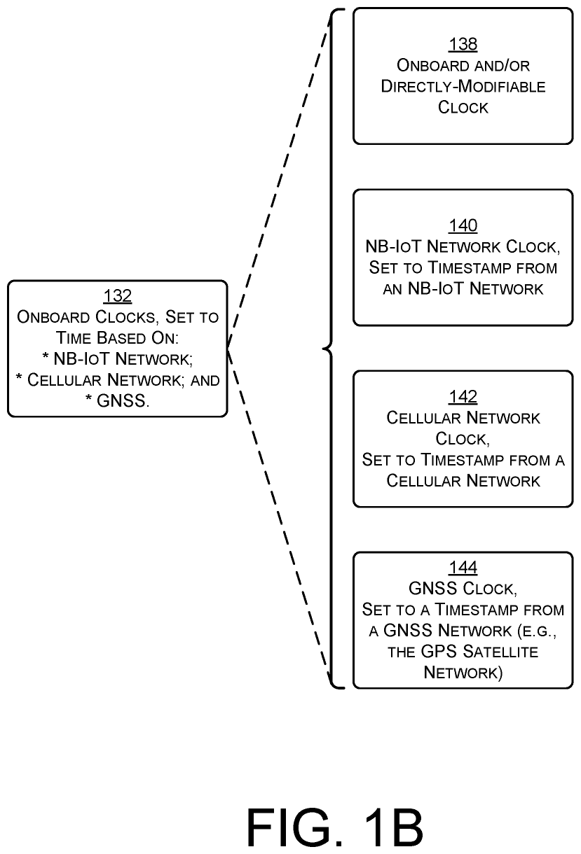

Example onboard clocks 132 may be set according to time-sources such as the NB-IoT network 106, one or more cellular networks 108, and/or one or more GNSS networks 110. Each clock may be considered to be valid (i.e., a “trusted” time) or invalid (i.e., not trusted). Additionally, the clocks may be configured in a hierarchy, in that a valid GNSS clock (i.e., a clock set using a timestamp obtained from a GNSS source) is considered to be more accurate than a valid cellular clock (i.e., a clock set using a timestamp obtained from a cellular network). The valid cellular clock is considered to be more accurate than a valid clock set using the high-latency network 106 (e.g., a NB-IoT network). Any valid clock is considered to be more accurate than any invalid clock. FIGS. 2 through 13 describe methods by which clock validity is checked and/or determined, by which clocks are set, and by which clocks are reset.

Radio(s) and antenna(s) 134 are adapted for one-and/or two-way communications with the high-latency network(s) 106, the cellular network(s) 108, and GNSS network(s) 110.

A battery and/or power supply 136 provides voltage-regulated power to the network device 102. In examples, an electricity meter may obtain electrical power from the smart electrical grid, while a gas or water meter may obtain power from a battery.

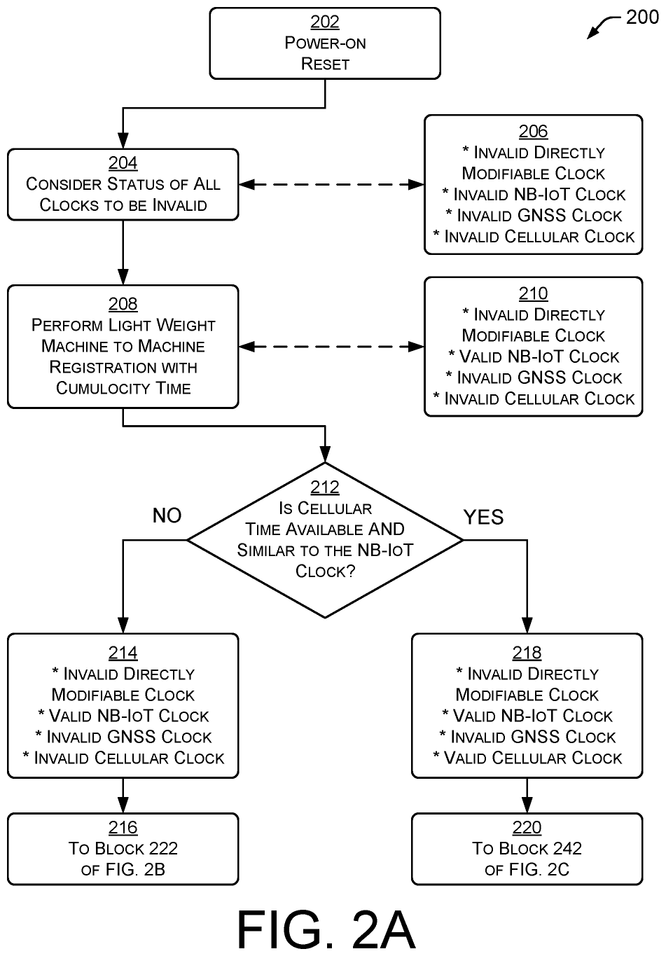

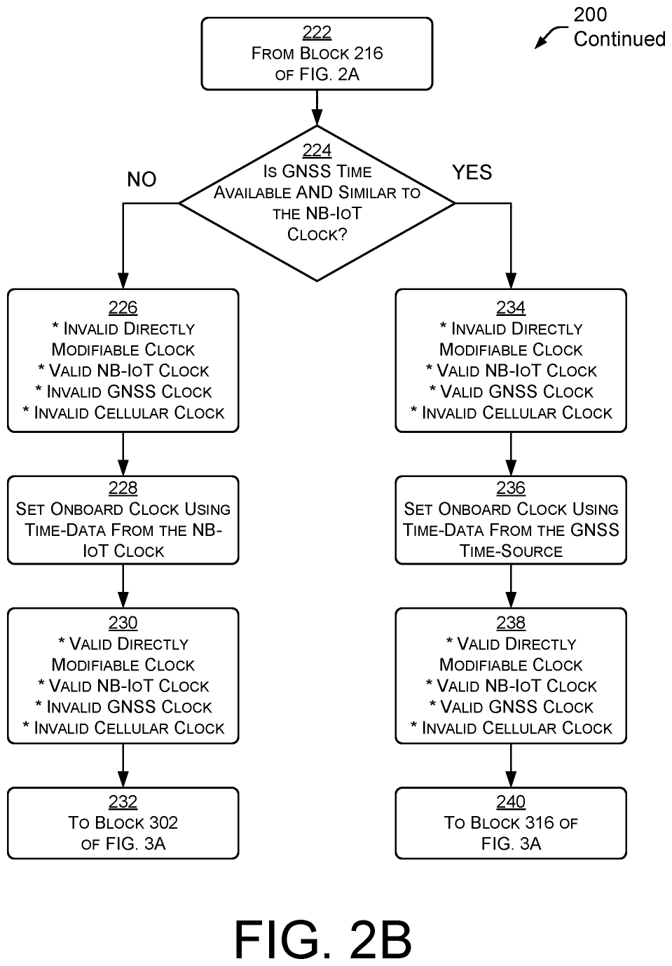

FIG. 1B is a block diagram showing added detail of the clocks 132 of network device 102 of FIG. 1A. An onboard directly-modifiable clock 138 may be used to control operations of the network device 102, such as the timing of RF transmissions, the timing of RF receptions, the timing of software executions, etc. Accordingly, the onboard clock 138 is a device included within the network device 102 that is set or reset based on the time of one of clocks 140-144. Thus, the onboard directly-modifiable clock 138 may be set or reset according to: a network-provided time (e.g., shown by the NB-IoT network clock 140); a cellular-provided time (e.g., shown by cellular network clock 142); or a GNSS-provided time (e.g., shown by GNSS clock 144). Which of the three clocks 140-144 is used to set and/or reset the directly modifiable clock 138 (which is used in the operation of the device 102) is the subject of FIGS. 2A through 3B, and also FIGS. 4 through 12.

Accordingly, selection of a clock used to set and/or reset the directly modifiable clock 138 is based at least in part on the issue of accuracy (which may be related to the latency of the network from which the time data was obtained) and the issue of reasonableness (which may be related to whether the network from which the time-data was obtained has been compromised, altered, hacked, jammed, signal-attenuated by obstructions, etc., and is sending inaccurate time information). In some examples, if similar time-information (e.g., timestamps within a threshold time-duration of each other) is available from two or more sources, then the time-source associated with a network having lower latency is selected for use by a device.

The NB-IoT network clock 140 can be set and/or reset by requesting and/or obtaining time-data (e.g., a date and timestamp) from the high-latency network 106. This time may not be precisely accurate, at least in part because the high-latency network 106 may have enough latency to introduce significant error to the time-data. The cellular network clock 142 may be set and/or reset using time-data provided by cellular network(s) 108. The GNSS clock 144 may be set and/or reset using time-data provided by a GNSS network(s) 110.

### Example Methods

In some examples, the techniques discussed herein may be implemented by one more processors accessing software defined on one or more memory devices. The processor(s) and memory device(s) may be located on an electricity meter and/or a cloud-based server (e.g., a server of a utility company). If the functionality is distributed, software may reside on both the electricity meter and the server.

In other examples of the techniques discussed herein, the methods of operation may be performed by one or more application specific integrated circuits (ASIC) or may be performed by a general-purpose processor utilizing software defined in computer readable media. In the examples and techniques discussed herein, the memory device 126 may comprise computer-readable media and may take the form of volatile memory, such as random-access memory (RAM) and/or non-volatile memory, such as read only memory (ROM) or flash RAM. Computer-readable media devices include volatile and non-volatile, removable, and non-removable media implemented in any method or technology for storage of information such as computer-readable instructions, data structures, program modules, or other data for execution by one or more processors of a computing device. Examples of computer-readable media include, but are not limited to, phase-change memory (PRAM), static random-access memory (SRAM), dynamic random-access memory (DRAM), other types of random access memory (RAM), read-only memory (ROM), electrically erasable programmable read-only memory (EEPROM), programmable read-only memory (PROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media includes non-transitory media. Computer-readable media does not include transitory media, such as modulated data signals and/or carrier waves, and/or other information-containing signals.

The computer-readable instructions stored on one or more non-transitory computer-readable storage media, when executed by one or more processors, may perform operations described above with reference to FIGS. 2A through 12. Generally, computer-readable instructions include routines, programs, objects, components, data structures, and the like that perform particular functions or implement particular abstract data types. The order in which the operations are described is not intended to be construed as a limitation, but as an example implementation, and any number of the described operations can be combined in any order and/or in parallel to implement the processes.

FIGS. 2 and 3 show example methods (e.g., to be incorporated by software executed by a device 102, 104) of setting and updating clocks 138-144 using data from networks 106-110. FIG. 2 shows an example method 200 showing actions performed by a network device (e.g., devices 102 and/or 104). The actions are performed beginning with power-on reset, and including a determination of the validity of clocks associated with systems 106-110, and including the setting of the directly modifiable clock 138 (onboard the device 102 and/or 104) using time-data from an appropriate network 106-110. FIG. 3 shows an example method 300 by which clocks are updated based on changes associated with networks 106-110. Example changes may include the reclassification of a timestamp from a network or system from invalid to valid, or the reverse.

Accordingly, at blocks 228, 236, 248, and 256, the onboard directly-modifiable clock 138 may be set using time-data from: a server on a higher-latency a NB-IoT network (which may be part of a cellular network); a lower-latency cellular network; or a still lower-latency GNSS network. At blocks 312, 322, 332, and 340 the clock 138 may be reset using time-data from those time-sources, as network conditions change over time in the different networks from which time-data is obtained.

At block 202, a power-on reset is performed, thereby “booting up” the network device. In the example of FIG. 1, the network device 102 is booted up. In particular, when power is provided by battery and/or power supply 136 the processor 124 accesses executable software (e.g., the operating system 128) thereby initiating activities related to a power-on reset. With the operating system active, a number of software objects may be executed (not shown for clarity). In particularly, the time-synchronization software adapted for high-latency networks 130 begins to be executed by the processor 124.

At block 204, the status of all clocks is set to, or considered to be, invalid. The clocks typically include both date and time information, with “time” frequently being considered to mean “date and time.” Block 206 shows an example of the clocks of a network device that are initially considered to be invalid. In the example, the clocks may include: the directly modifiable clock 138 (to be set later using time-data from one of clocks 140-144, which was obtained from servers on networks 106-110); the clock used to store time data from the high-latency network 106 (e.g., the NB-IoT clock 140); the clock used to store time data from the cellular network 108 (e.g., cellular clock 142); and one or more GNSS clocks 144, used to store time data from a respective one or more GNSS, such as GPS. With all clocks considered to be invalid, the method 200 proceeds to look for valid time-sources and to consider the network latency and network security of such time-sources.

At block 208, light weight machine to machine (LwM2M) registration is performed, and a timestamp is received over the high-latency network 106 from a server (e.g., from an NB-IoT server of the Cumulocity IoT platform). Accordingly, the registration process updates the NB-IoT clock 140 using information from the NB-IoT server. Block 210 shows an example of the clocks that are considered to be valid and invalid following the registration. The NB-IoT clock 140 (on the device performing the method 200) is considered valid (due to the registration process), while other clocks are still considered to be invalid.

At block 212, it is determined if a cellular time value is available, and if so, if the cellular time value is similar to (e.g., within a threshold value of) the newly reset onboard directly-modifiable clock (set to an NB-IoT time value). If the cellular time value is available, it is used to reset the cellular clock 142.

If the cellular network clock 142 and NB-IoT time values (e.g., from clocks 138 and/or 140) differ by more than the threshold value, at block 214 the cellular clock 142 continues to be considered invalid. Alternatively, if the cellular clock 142 and NB-IoT time values differ by less than the threshold value, at block 218 the cellular clock 142 is considered to be valid.

At block 224, the cellular network clock 142 is now considered to be invalid, and a further attempt to obtain accurate time information is desired. Accordingly, at block 224, it is determined: (1) if time information (e.g., a date and timestamp) is available from a GNSS source, such as GPS satellite(s); and (2) if time-data from the GNSS source is similar to (e.g., within a threshold of) the NB-IoT time obtained at block 208 (and stored in clock 140). A date and timestamp may be obtained from a GNSS source by operation of a GNSS radio and antenna, such as from among radios 134. At block 226, the GNSS timestamp could not be obtained and/or it was not within a threshold time duration of the NB-IoT time (e.g., the NB-IoT clock 140). Accordingly, at block 226 the GNSS clock 144 is considered to be invalid.

At block 228 the onboard clock 138 is set using time-data from the NB-IoT clock 140. Accordingly at block 230, the NB-IoT clock 140 and the onboard and/or directly modifiable clock 138 are considered to be accurate. (Note, the onboard clock 138 was set using time-data obtained from the NB-IoT clock 140.) However, the cellular clock 142 and the GNSS clock 144 are considered to be invalid.

At block 234, the GNSS timestamp was obtained (and used to reset the GNSS clock 144), and was within a threshold time duration of the NB-IoT time (e.g., clock 140). Accordingly, at block 234 the GNSS clock 144 and the NB-IoT clock 140 are considered to be valid.

At block 236 the onboard clock 138 is set using time-data from the GNSS clock 144. Accordingly at block 238, the NB-IoT clock 140, the onboard and/or directly modifiable clock 138, and the GNSS clock 144 are considered to be accurate. However, the cellular clock 142 is considered to be invalid.

Returning to FIG. 2A, at block 212, if the cellular time and NB-IoT time differed by more than a threshold time value, then the conditions described by block 214 were assumed and FIG. 2B was utilized. FIG. 2B explores the possible use of GNSS-provided time under conditions wherein cellular-provided time is not available. However, if the cellular time and NB-IoT time were within the threshold time value, then the conditions described by block 218 were assumed and FIG. 2C is utilized. FIG. 2C explores the possible use of GNSS-provided time under conditions wherein cellular-provided time is available.

At block 244, it is determined if GNSS clock 144 (recently set using a GNSS system) is available and is similar to the NB-IoT clock 140. If the times differ by more than a threshold, (i.e., GNSS-provided time is available and is not similar to the NB-IoT-provided time), then the conditions of block 246 are assumed.

Block 246 (after the decision of block 244) shows the situation wherein the GNSS time is not available and/or the GNSS time is not similar to the NB-IoT clock. At block 246, the NB-IoT clock 140 and the cellular clock 142 are considered to be valid, while the GNSS clock 144 and the onboard directly modifiable clock 138 are considered to be invalid.

At block 248, the onboard clock 138 is set using the cellular clock 142 (and/or the associated cellular-provided time-data) and is then considered to be valid. Accordingly, the information of block 246 is updated at block 250 to indicate that the onboard clock 138 is considered to be valid.

Block 254 (after the decision of block 244) shows the situation wherein the GNSS time is available and is similar to the NB-IoT clock. At block 254, the NB-IoT clock 140, the cellular clock 142, and the GNSS clock 144 are considered to be valid, while the onboard directly modifiable clock 138 is considered to be invalid (because it has not yet been reset using one of clocks 140-144).

At block 256, the onboard clock 138 is set using the GNSS clock 144 (and/or the associated GNSS-provided time-data) and is then considered to be valid. Accordingly, the information of block 254 is updated at block 258 to indicate that the onboard directly modifiable clock 138 is considered to be valid.

FIG. 3 shows an example method 300 (e.g., for execution by a device 102, 104) by which clocks are updated based on changes associated with time-providing systems and/or devices within or using networks 106-110. The algorithm of the method 300 is entered in four different locations, based on different conditions of FIG. 2. Block 232 of FIG. 2 connects to block 302 of FIG. 3, and is associated with a valid onboard clock 138 and a valid NB-IoT clock 140, but invalid cellular clock 142 and GNSS clock 144. Block 240 of FIG. 2 connects to block 316 of FIG. 3, and is associated with valid onboard, NB-IoT, and GNSS clocks, but an invalid cellular clock. Block 252 of FIG. 2 connects to block 324 of FIG. 3, and is associated with valid onboard, NB-IoT, and cellular clocks, but an invalid GNSS clock. Block 260 of FIG. 2 connects to block 334 of FIG. 3, and is associated with valid onboard, NB-IoT, cellular, and GNSS clocks. Thus, in the updating method 300 of FIG. 3, the time-source used by the network device is changed, has four starting positions, and is based on: (1) no valid cellular or GNSS time-data; (2) valid GNSS time but invalid cellular time (3) valid cellular and invalid GNSS time, and (4) valid cellular and valid GNSS time.

At block 302, the NB-IoT clock (and the onboard clock 138, which was set at block 228 using the NB-IoT clock 140) is the only valid clock. At block 304, it is determined if a threshold or preset time has elapsed without receiving a time update from NB-IoT. If true, at block 306, periodically, occasionally, and/or at other intervals a request is made for a timestamp from the NB-IoT network 106. Thus, the NB-IoT clock 140 is updated. In examples, the timestamp may be acquired as part of a request, a registration and/or a re-registration process. In further examples, the

At block 308, periodically, occasionally, and/or at other intervals a check is performed to determine if the GNSS time is similar to (e.g., within a threshold time value of) the onboard clock 138. The onboard clock 138 may have been set by data from the NB-IoT network 106, the cellular time-source 108, or the GNSS time-source 110 (e.g., at blocks 228, 236, 248, or 256 of FIG. 2B and 2C). At block 310, it is determined if the GNSS clock 144 (recently updated by the GNSS system 110) is within a threshold value of the onboard clock 138. If not, then block 308 is repeated (that is, the system waits for the GNSS time to be “repaired,” such as by discontinuation of a jamming signal). If the GNSS time is within the threshold value, then at block 312 the onboard clock 138 is reset using the GNSS time value. At block 314, control moves to block 334 of FIG. 3B.

At block 304, if the preset (or threshold) time has not elapsed, then at block 322 the onboard clock 138 is set using the NB-IoT time-source or clock 140. Once set to this time (which is based on the high-latency network 106), the system moves to block 308 to check for “repair” of the GNSS time-source.

At block 316, the NB-IoT time, GNSS time, and the onboard clock are all considered valid, while the cellular clock is considered invalid. At block 318, periodically, occasionally, and/or at other intervals a check is performed wherein the onboard clock 138 is compared to the GNSS clock 144. At block 320, if no sudden difference in the GNSS clock 144 (e.g., caused by jamming or spoofing of the GNSS signal), then control is returned to block 318 for continued observation. That is, the GNSS appears to be fine, but continued observation is prudent. If a significant difference is detected (e.g., indicating that the GNSS signal has been obscured, blocked, jammed, and/or spoofed, etc.) then at block 322 the onboard clock is reset using NB-IoT data. That is, if the GNSS time appears to have become invalid, the onboard clock 138 is set using the NB-IoT clock 140, thereby reverting to the more-trusted but more highly-latent NB-IoT time-source of network 106. Having reset the onboard clock 138 to a less-preferred time-source at block 322, at block 308 it is determined if and/or when the onboard clock can be reset using a GNSS time-source. Note that block 322 may alternatively be connected to block 306. That is the output of block 322 may be routed to either 306 or 308, depending on design goals.

At block 324, the GNSS clock is invalid, but other clocks are valid (see block 250 of FIG. 2C). At block 326, periodically, occasionally, and/or at other intervals an update of the onboard clock 138 is performed using time-data provided by the cellular network 108. In an example, the update (i.e., clock reset) may be performed by reattaching to a cellular network.

At block 328, periodically, occasionally, and/or at other intervals the GNSS clock 144 (reset by the GNSS system 110) is compared to the onboard clock 138. At block 330, it is determined if the GNSS time or clock 144 is similar to the onboard clock 138 over a duration (e.g., over a threshold period of time). This may indicate whether the GNSS signal is still being jammed or spoofed. If the GNSS time is not similar to the onboard clock over the duration, then control moves back to block 328, for a subsequent check. If the GNSS time is similar over the duration, at block 332 the onboard clock 138 is reset using the GNSS time-data of the GNSS clock 144. That is, the confidence in the GNSS time is sufficient to reset the onboard clock and begin to use GNSS-sourced time-data.

At block 336, periodically, occasionally, and/or at other intervals the GNSS clock 144 (refreshed by the GNSS 110) is checked against the onboard clock 138. At block 338, it is determined if there is a difference over a threshold (e.g., a sudden and/or significant difference between GNSS time and the time of the onboard clock). If not, control moves to block 336 for continued observation of the GNSS time-source. If there is a significant difference (e.g., greater than a threshold time value), then at block 340 the onboard clock 138 is reset using cellular-sourced time-data. Having set the onboard clock 138 using the cellular clock 142 (which is updated using data from the cellular time-source), control moves to block 326 to update the cellular time-data and (at block 328) and to determine if the use of such time-data may be replaced with GNSS time-data.

FIG. 4 shows an example method 400 of operation of a networked device (e.g., network device 102) to perform techniques for time synchronization in a system having a high-latency network (e.g., system 100 with high-latency network 106).

At block 402, a first timestamp is obtained from a first time-source (e.g., a NB-IoT network, such as high-latency network 106) having a first expected latency. In an example, the timestamp is used to set the clock 140 of FIG. 1B).

At block 404, a second timestamp is obtained from a second time-source (e.g., a cellular network or a GNSS) having a second expected latency, wherein the second expected latency is less than the first expected latency. In an example, the timestamp is used to set the cellular clock 142 or the GNSS clock 144.

At block 406, either the first time-source or the second time-source is selected for use in resetting the onboard clock 138. In an example, the selection may be made using the method of blocks 408 through 412. At block 408, it is determined if the first timestamp and the second timestamp are within a threshold difference of one another. The NB-IoT time-source is more trusted, but the lower latency associated with the second timestamp is more desirable. At block 410, the first time-source is selected if the first timestamp and the second timestamp are not within the threshold difference. That is, exceeding the threshold difference casts doubt over the validity of the time-source associated with lower latency, provided the threshold is set to a greater value than the latency of the higher-latency network. At block 412, the second time-source is selected if the first timestamp and the second timestamp are within the threshold difference. That is, if the first and second timestamps are within the threshold (set greater than latency), then the timestamp from the lower latency network (cellular or GNSS) is presumed to be more accurate.

At block 414, an onboard clock (e.g., clock 138) of the networked device (e.g., device 102) is set using the selected time-source. At block 416, the onboard clock 138 is utilized to perform a data transmission or other task requiring an accurate time.

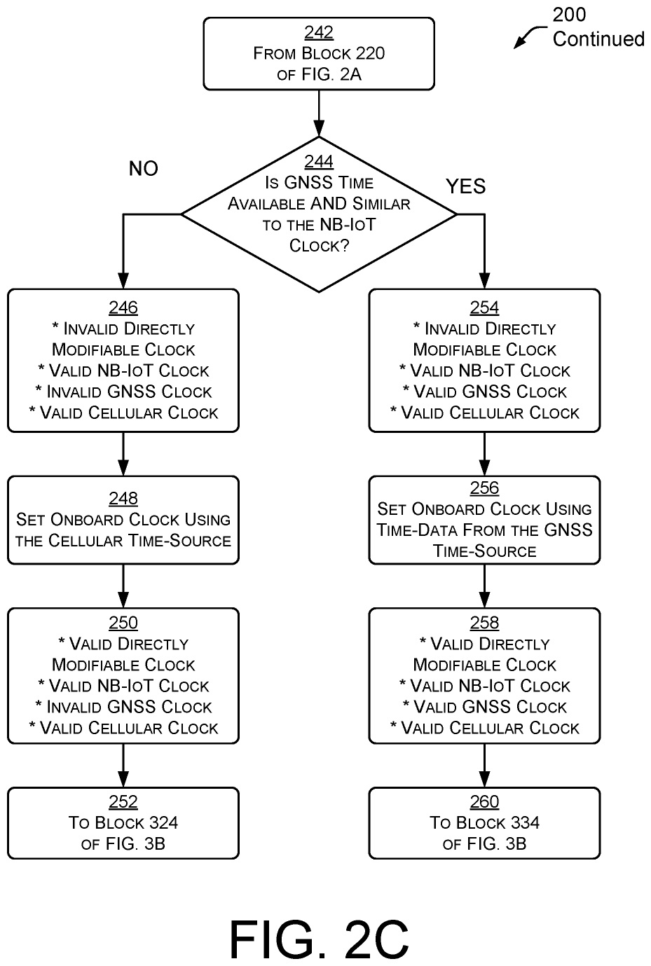

FIG. 5 shows an example method 500 by which the onboard clock may be reset using a GNSS time-source. At block 502, the onboard clock is compared to time-data from a global navigation satellite system (GNSS). In an example, the clocks 138-144 are updated as practical and/or possible. The onboard clock 138 is set to the time currently thought to be the most accurate. The onboard clock 138 may be compared to the GNSS clock 144. At block 504, it is determined that a timestamp of the GNSS is within a first threshold value of time-data of the onboard clock for a period over a second threshold value of time duration. That is, if the onboard clock 138 is sufficiently similar (less than a threshold difference) to the GNSS clock 144 for a sufficient time (e.g., a second threshold) then it is assumed that the GNSS time is accurate. If the times are not similar at some point(s) as the second threshold time-period passes, then the GNSS time may have been jammed, spoofed, or otherwise tampered with, and should be avoided. At block 506, the onboard clock is reset using GNSS time-data. Thus, in view of the success at block 504, the onboard clock 138 is reset using a time value from the GNSS clock 144.

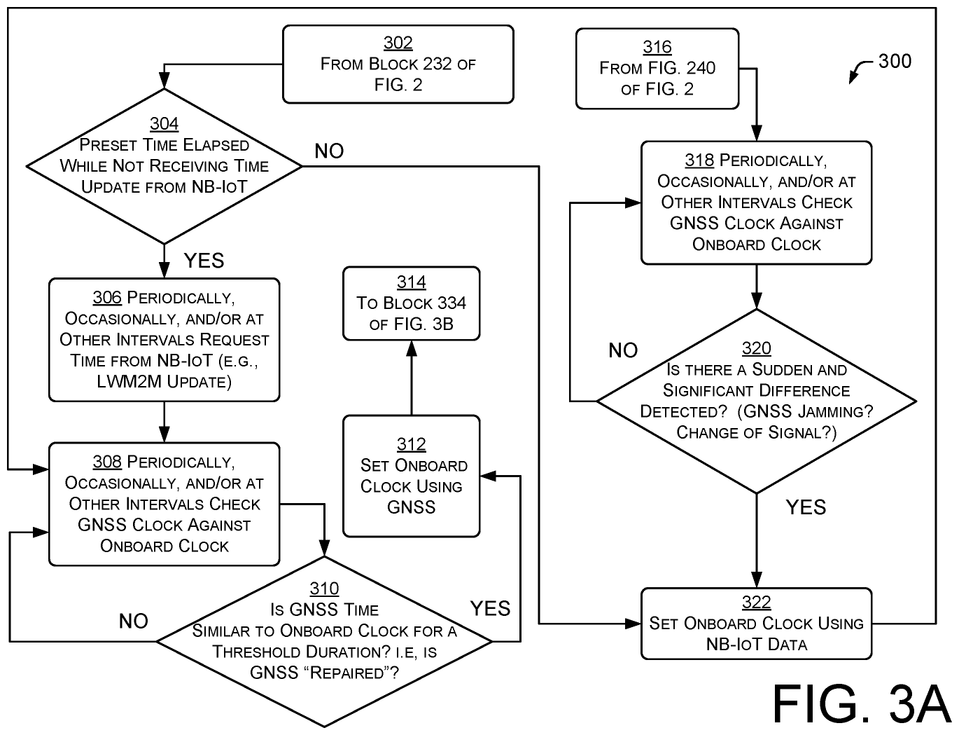

FIG. 6 shows an example method 600 by which the onboard clock may be reset using cellular-sourced time-data. While the cellular time may not be quite as accurate as the GNSS time, and may vary among cell towers and/or cell companies, the cellular time is an improvement over a time value obtained from an NB-IoT type network (e.g., network 106). At block 602, the onboard clock 138 is compared to time-data of a GNSS (e.g., clock 144). At block 604, it is determined that the time-data of the GNSS is not within a first threshold value of time-data of the onboard clock for a period over a second threshold value duration. That is, the GNSS fails block 504 of the previous figure, FIG. 5. However, if the cellular clock 142 is considered valid, then use of the cellular clock is preferred over the NB-IoT clock 140. Accordingly, at block 606 the onboard clock 138 is reset using cellular clock 142.

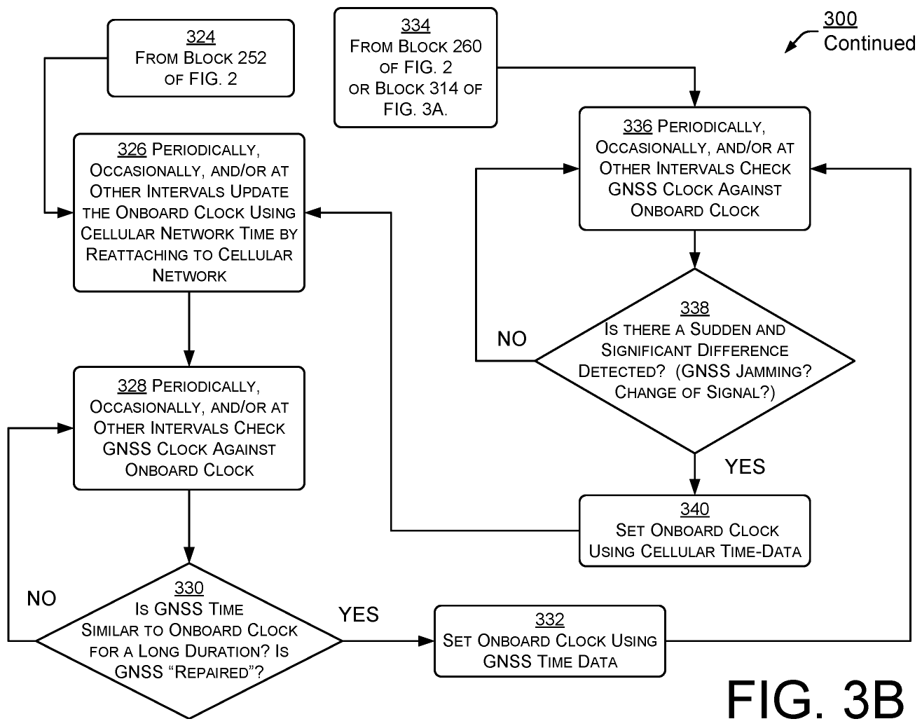

FIG. 7 shows an example method 700 by which the onboard clock may be reset using NB-IoT network-sourced time-data after a GNSS time-source is found to be invalid. However, unlike method 600 wherein the cellular clock was valid, in method 700 the NB-IoT clock must be used. At block 702, the onboard clock is compared to time-data of a global navigation satellite system (GNSS). At block 704 (similarly to block 604 of FIG. 6), it is determined that time-data of the GNSS differs by more than a threshold value from time-data of the onboard clock. Accordingly, at block 706, the onboard clock is reset using NB-IoT time-data.

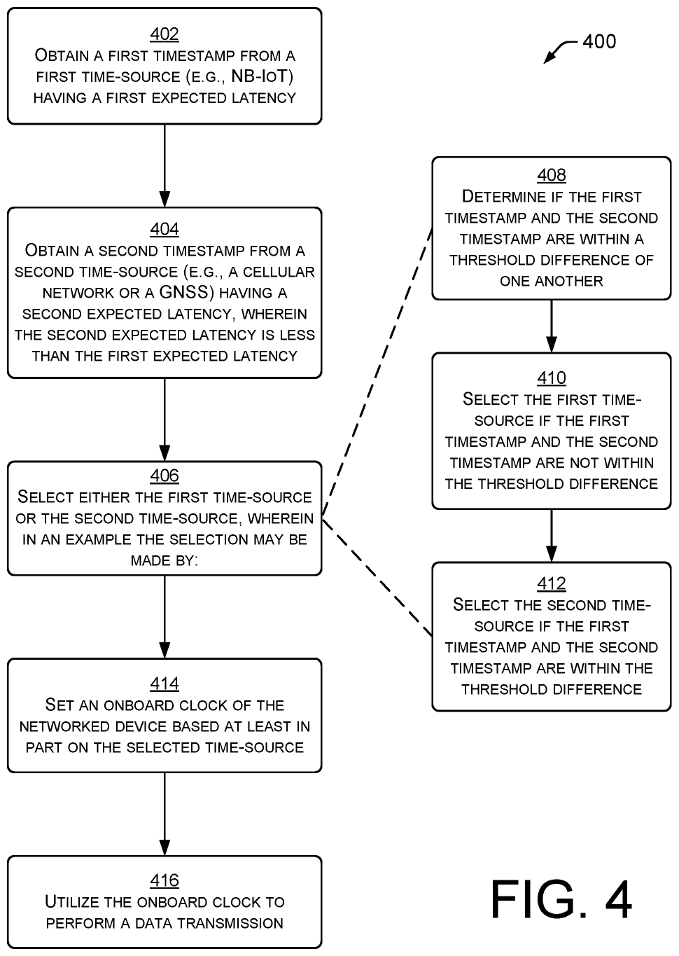

FIG. 8 shows an example method 800 by which the onboard clock may be reset using a NB-IoT time-source. At block 802, a cellular time-source is determined to be invalid. At block 804, a GNSS time-source is determined to be invalid. At block 806, the onboard clock is reset using time-data from a NB-IoT network.

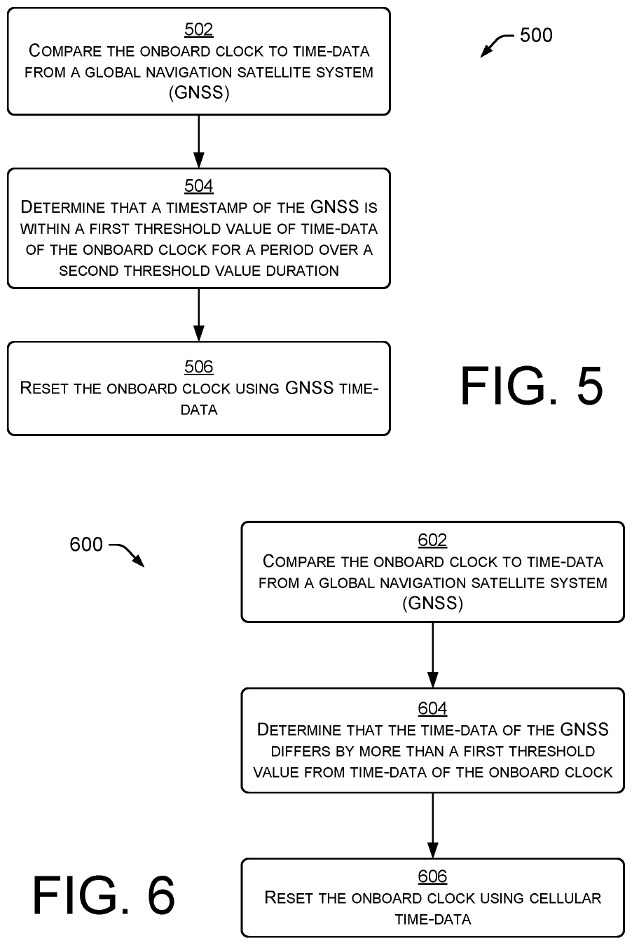

FIG. 9 shows a further example method 900 to operate a networked device performing techniques for time synchronization in a high-latency network.

At block 902, an onboard clock is set using a secure source in a network through a lightweight machine to machine (LwM2M) registration process. In one example, the registration process may use a public key for security. At block 904, it is determined if a global network satellite system (GNSS) timestamp of a GNSS is available and within a first threshold time period from the onboard clock. At block 906, if the GNSS timestamp is available and within the first threshold time period from the onboard clock, then the time-data of the GNSS is considered to be validated. At block 908, if the GNSS is not available or not within the first threshold time period from the onboard clock, then it is determined if a cellular network timestamp is available from a cellular network and within a second (or the same first) threshold time period from the onboard clock. At block 910, if the cellular network timestamp is available and within the second threshold time period from the onboard clock, then the time-data of the cellular network is considered to be validated. At block 912, the onboard clock (e.g., clock 138) of the device (e.g., device 102) is reset based at least in part on the validated time-source, wherein the validated time-source was obtained from either the GNSS or the cellular network.

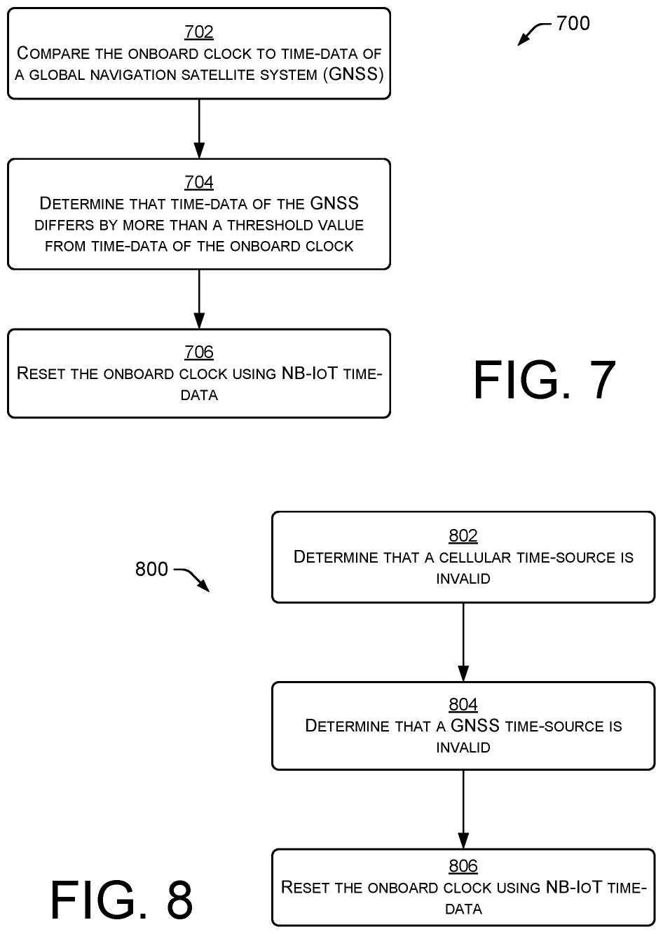

FIG. 10 shows an example method 1000 by which latency of a network is estimated, and (based at least in part on the estimations) the thresholds used in the method 900 are adjusted. For example, if a first network has high-latency a longer threshold period may be used, to see if a timestamp from a second network is “reasonable.” That is, the threshold periods used may have to be longer than the latency period of packet transmission. At block 1002, latency of the network (e.g., network 106) is estimated. The estimate of the latency may be based on a measurement, in that the latency of the network may be changing, and a measurement of current latency may be used as an estimate of future latency. At block 1004, at least one of the first threshold time period or the second threshold time period is adjusted based on the estimated latency. In an example, if the latency is estimated to be less, then the first threshold can be reduced. That is, if the latency is less, then the two time-values are expected to be closer if they are both valid.

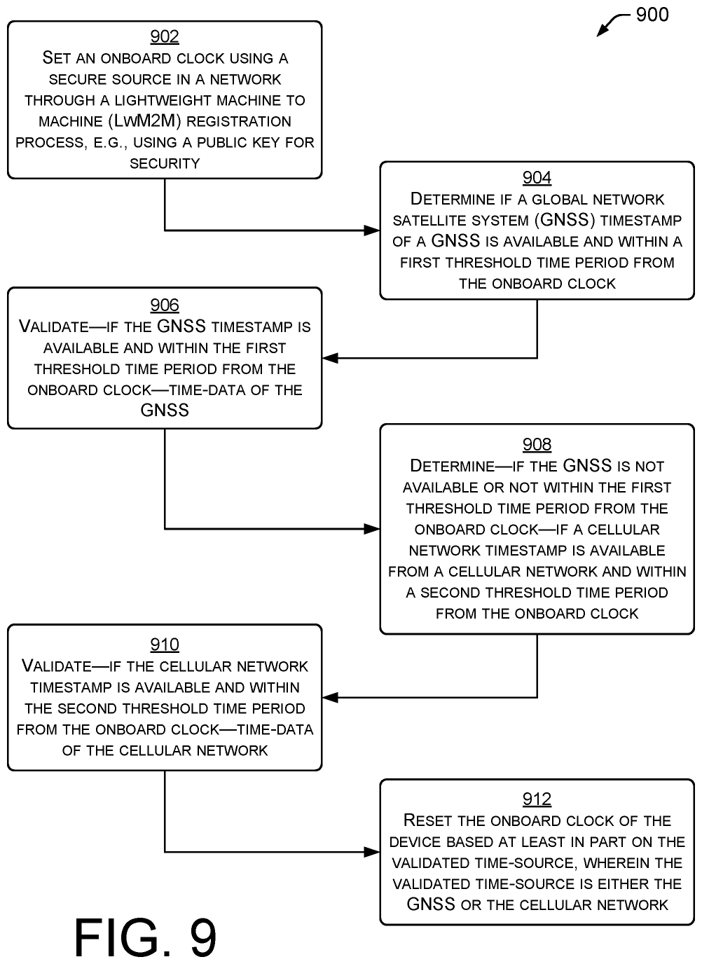

FIG. 11 shows an example method 1100 by which a network device uses a GNSS time-source if it is validated, but uses a cellular time-source if the GNSS is not validated. At block 1102, the onboard clock (e.g., clock 138) of the device (e.g., device 102) is set using the GNSS if it is validated. However, at block 1104, the onboard clock is set using the cellular network if it is validated and the GNSS is not validated.

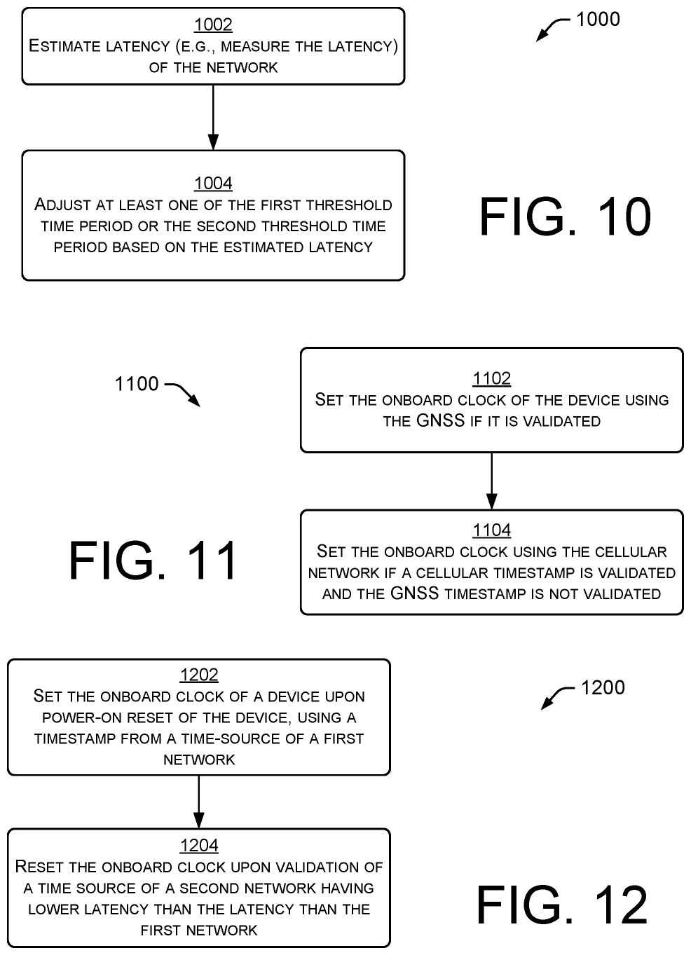

FIG. 12 shows an example method 1200 by which a network device switches from a high-latency time-source to a lower latency time-source. At block 1202, the onboard clock of the device is set upon power-on reset using the timestamp from time-source in the network. At block 1204, the onboard clock is updated (i.e., reset) upon validation of a time-source having lower latency than the latency of the network.

### Example Systems, Devices, and Methods

The following examples of time synchronization in a high-latency network are expressed as numbered clauses. While the examples illustrate a number of possible configurations and techniques, they are not meant to be an exhaustive listing of the systems, methods, and/or techniques described herein.
1. A method of managing time information in a networked device, comprising: obtaining a first timestamp from a first time-source having a first expected latency; obtaining a second timestamp from a second time-source having a second expected latency, wherein the second expected latency is less than the first expected latency; selecting either the first time-source or the second time-source, wherein the selecting comprises: determining if the first timestamp and the second timestamp are within a threshold difference of one another; selecting the first time-source if the first timestamp and the second timestamp are not within the threshold difference; and selecting the second time-source if the first timestamp and the second timestamp are within the threshold difference; setting an onboard clock of the networked device based at least in part on the selected time-source; and utilizing the onboard clock to perform a data transmission.
2. The method of clause 1, wherein: the first time-source is a narrow band internet of things (NB-IoT) network; and the second time-source is a global navigation satellite system (GNSS).
3. The method of clause 1, wherein: the first time-source is a narrow band internet of things (NB-IoT) network; and the second time-source is a cellular network.
4. The method of clause 1, additionally comprising: comparing the onboard clock to time-data of a global navigation satellite system (GNSS); determining that a timestamp of the GNSS is within a second threshold value of time-data of the onboard clock for a period over a third threshold value duration; and setting, responsive to a positive determination, the onboard clock using the GNSS.
5. The method of clause 1, additionally comprising: comparing the onboard clock to time-data of a global navigation satellite system (GNSS); determining that the time-data of the GNSS differs by more than the threshold value from time-data of the onboard clock; and resetting the onboard clock using time-data from a cellular system.
6. The method of clause 1, additionally comprising: comparing the onboard clock to time-data of a global navigation satellite system (GNSS); determining that time-data of the GNSS differs by more than a second threshold value from time-data of the onboard clock; and setting the onboard clock using time-data from a narrow band internet of things (NB-IoT) network.
7. The method of clause 1, additionally comprising: determining that a cellular time-source is invalid; determining that a GNSS time-source is invalid; and resetting the onboard clock using time-data from a NB-IoT.
8. The method as recited in clause 1, additionally comprising one or more of, or any combination of, or all of, any of the preceding clauses.
9. A device, comprising: a processor; a memory device in communication with the processor, wherein the memory device comprises statements executed by the processor to perform actions comprising: setting an onboard clock using a secure source in a network through a lightweight machine to machine (LwM2M) registration process; determining if a global network satellite system (GNSS) timestamp of a GNSS is available and within a first threshold time period from the onboard clock; validating, if the GNSS timestamp is available and within the first threshold time period from the onboard clock, time-data of the GNSS; determining, if the GNSS is not available or not within the first threshold time period from the onboard clock, if a cellular network timestamp is available from a cellular network and within a second threshold time period from the onboard clock; validating, if the cellular network timestamp is available and within the second threshold time period from the onboard clock, time-data of the cellular network; and resetting the onboard clock of the device based at least in part on the validated time-source, wherein the validated time-source is either the GNSS or the cellular network.
10. The device as recited in clause 9, wherein the actions additionally comprise: estimating latency of the network; and adjusting at least one of the first threshold time period or the second threshold time period based on the estimated latency.
11. The device as recited in clause 9, wherein the actions additionally comprise at least one of: setting the onboard clock of the device using the GNSS if it is validated; or setting the onboard clock using the cellular network if it is validated and the GNSS is not validated.
12. The device as recited in clause 9, wherein the actions additionally comprise: setting the onboard clock of the device upon power-on reset using the timestamp from the secure source in the network; and resetting the onboard clock upon validation of a time-source having lower latency than the latency of the network.
13. The device as recited in clause 9, wherein the actions additionally comprise: updating the onboard clock of the device based on the cellular network; or updating the onboard clock of the device based on the GNSS.
14. The device as recited in clause 9, wherein the device additionally comprises: a GNSS radio configured to receive signals from the GNSS; and a cellular radio configured to receive signals from the cellular network.
15. The device as recited in clause 9, wherein the actions additionally comprise: resetting the onboard clock using data from the cellular network; or resetting the onboard clock using data from a GNSS.
16. The device as recited in clause 9, additionally comprising one or more of, or any combination of, or all of, any of the preceding clauses.
17. One or more non-transitory computer-readable media storing computer-executable instructions that, when executed by one or more processors, configure a computing device to perform actions comprising: obtaining a first timestamp from a first time-source having a first expected latency; obtaining a second timestamp from a second time-source having a second expected latency, wherein the second expected latency is less than the first expected latency; selecting either the first time-source or the second time-source, wherein the selecting comprises: determining if the first timestamp and the second timestamp are within a threshold difference of one another; selecting the first time-source if the first timestamp and the second timestamp are not within the threshold difference; and selecting the second time-source if the first timestamp and the second timestamp are within the threshold difference; setting an onboard clock of a networked device based at least in part on the selected time-source; and utilizing the onboard clock to perform a data transmission.
18. One or more non-transitory computer-readable media as recited in clause 17, wherein: the first time-source is a narrow band internet of things (NB-IoT) network; and the second time-source is a cellular network.
19. One or more non-transitory computer-readable media as recited in clause 17, wherein: the first time-source is a narrow band internet of things (NB-IoT) network; and the second time-source is a global navigation satellite system (GNSS).
20. One or more non-transitory computer-readable media as recited in clause 17, wherein the actions additionally comprise: comparing the onboard clock to time-data of a global navigation satellite system (GNSS); determining that a timestamp of the GNSS is within a first threshold value of time-data of the onboard clock for a period over a second threshold value duration; and setting, responsive to a positive determination, the onboard clock using the GNSS.
21. One or more non-transitory computer-readable media as recited in clause 17, wherein the actions additionally comprise: comparing the onboard clock to time-data of a global navigation satellite system (GNSS); comparing the onboard clock to time-data of a cellular system; determining that the time-data of the GNSS differs by more than the threshold value from time-data of the onboard clock; and resetting the onboard clock using time-data from the cellular system.
22. One or more non-transitory computer-readable media as recited in clause 17, wherein the actions additionally comprise: comparing the onboard clock to time-data of a global navigation satellite system (GNSS); determining that time-data of the GNSS differs by more than a second threshold value from time-data of the onboard clock; and setting the onboard clock using time-data from a narrow band internet of things (NB-IoT) network.
23. The one or more non-transitory computer-readable media as recited in clause 17, additionally comprising one or more of, or any combination of, or all of, any of the preceding clauses.

### CONCLUSION

Although the subject matter has been described in language specific to structural features and/or methodological actions, it is to be understood that the subject matter defined in the appended claims is not necessarily limited to the specific features or actions described. Rather, the specific features and actions are disclosed as exemplary forms of implementing the claims. The words comprise, comprises, and/or comprising, when used in this specification and/or claims do not preclude the presence or addition of one or more other features, devices, techniques, and/or components and/or groups thereof.

1. A method of managing time information in a networked device, comprising:
obtaining a first timestamp from a first time-source having a first expected latency;
obtaining a second timestamp from a second time-source having a second expected latency, wherein the second expected latency is less than the first expected latency;
selecting either the first time-source or the second time-source, wherein the selecting comprises:
determining if the first timestamp and the second timestamp are within a threshold difference of one another;
selecting the first time-source if the first timestamp and the second timestamp are not within the threshold difference; and
selecting the second time-source if the first timestamp and the second timestamp are within the threshold difference;
setting an onboard clock of the networked device based at least in part on the selected time-source; and
utilizing the onboard clock to perform a data transmission.

2. The method of claim 1, wherein:
the first time-source is a narrow band internet of things (NB-IoT) network; and
the second time-source is a global navigation satellite system (GNSS).

3. The method of claim 1, wherein:
the first time-source is a narrow band internet of things (NB-IoT) network; and
the second time-source is a cellular network.

4. The method of claim 1, additionally comprising:
comparing the onboard clock to time-data of a global navigation satellite system (GNSS);
determining that a timestamp of the GNSS is within a second threshold value of time-data of the onboard clock for a period over a third threshold value duration; and
setting, responsive to a positive determination, the onboard clock using the GNSS.

5. The method of claim 1, additionally comprising:
comparing the onboard clock to time-data of a global navigation satellite system (GNSS);
determining that the time-data of the GNSS differs by more than the threshold value from time-data of the onboard clock; and
resetting the onboard clock using time-data from a cellular system.

6. The method of claim 1, additionally comprising:
comparing the onboard clock to time-data of a global navigation satellite system (GNSS);
determining that time-data of the GNSS differs by more than a second threshold value from time-data of the onboard clock; and
setting the onboard clock using time-data from a narrow band internet of things (NB-IoT) network.

7. The method of claim 1, additionally comprising:
determining that a cellular time-source is invalid;
determining that a GNSS time-source is invalid; and
resetting the onboard clock using time-data from a NB-IoT.

8. A device, comprising:
a processor;
a memory device in communication with the processor, wherein the memory device comprises statements executed by the processor to perform actions comprising:
setting an onboard clock using a secure source in a network through a lightweight machine to machine (LwM2M) registration process;
determining if a global network satellite system (GNSS) timestamp of a GNSS is available and within a first threshold time period from the onboard clock;
validating, if the GNSS timestamp is available and within the first threshold time period from the onboard clock, time-data of the GNSS;
determining, if the GNSS is not available or not within the first threshold time period from the onboard clock, if a cellular network timestamp is available from a cellular network and within a second threshold time period from the onboard clock;
validating, if the cellular network timestamp is available and within the second threshold time period from the onboard clock, time-data of the cellular network; and
resetting the onboard clock of the device based at least in part on the validated time-source, wherein the validated time-source is either the GNSS or the cellular network.

9. The device as recited in claim 8, wherein the actions additionally comprise:
estimating latency of the network; and
adjusting at least one of the first threshold time period or the second threshold time period based on the estimated latency.

10. The device as recited in claim 8, wherein the actions additionally comprise at least one of:
setting the onboard clock of the device using the GNSS if it is validated; or
setting the onboard clock using the cellular network if it is validated and the GNSS is not validated.

11. The device as recited in claim 8, wherein the actions additionally comprise:
setting the onboard clock of the device upon power-on reset using the timestamp from the secure source in the network; and
resetting the onboard clock upon validation of a time-source having lower latency than the latency of the network.

12. The device as recited in claim 8, wherein the actions additionally comprise:
updating the onboard clock of the device based on the cellular network; or
updating the onboard clock of the device based on the GNSS.

13. The device as recited in claim 8, wherein the device additionally comprises:
a GNSS radio configured to receive signals from the GNSS; and
a cellular radio configured to receive signals from the cellular network.

14. The device as recited in claim 8, wherein the actions additionally comprise:
resetting the onboard clock using data from the cellular network; or
resetting the onboard clock using data from a GNSS.

15. One or more non-transitory computer-readable media storing computer-executable instructions that, when executed by one or more processors, configure a computing device to perform actions comprising:
obtaining a first timestamp from a first time-source having a first expected latency;
obtaining a second timestamp from a second time-source having a second expected latency, wherein the second expected latency is less than the first expected latency;
selecting either the first time-source or the second time-source, wherein the selecting comprises:
determining if the first timestamp and the second timestamp are within a threshold difference of one another;
selecting the first time-source if the first timestamp and the second timestamp are not within the threshold difference; and
selecting the second time-source if the first timestamp and the second timestamp are within the threshold difference;
setting an onboard clock of a networked device based at least in part on the selected time-source; and
utilizing the onboard clock to perform a data transmission.

16. One or more non-transitory computer-readable media as recited in claim 15, wherein:
the first time-source is a narrow band internet of things (NB-IoT) network; and
the second time-source is a cellular network.

17. One or more non-transitory computer-readable media as recited in claim 15, wherein:
the first time-source is a narrow band internet of things (NB-IoT) network; and
the second time-source is a global navigation satellite system (GNSS).

18. One or more non-transitory computer-readable media as recited in claim 15, wherein the actions additionally comprise:
comparing the onboard clock to time-data of a global navigation satellite system (GNSS);
determining that a timestamp of the GNSS is within a first threshold value of time-data of the onboard clock for a period over a second threshold value duration; and
setting, responsive to a positive determination, the onboard clock using the GNSS.

19. One or more non-transitory computer-readable media as recited in claim 15, wherein the actions additionally comprise:
comparing the onboard clock to time-data of a global navigation satellite system (GNSS);
comparing the onboard clock to time-data of a cellular system;
determining that the time-data of the GNSS differs by more than the threshold value from time-data of the onboard clock; and
resetting the onboard clock using time-data from the cellular system.

20. One or more non-transitory computer-readable media as recited in claim 15, wherein the actions additionally comprise:
comparing the onboard clock to time-data of a global navigation satellite system (GNSS);
determining that time-data of the GNSS differs by more than a second threshold value from time-data of the onboard clock; and
setting the onboard clock using time-data from a narrow band internet of things (NB-IoT) network.
